(19) United States
(12) Patent Application Publication
(10) Pub. No.: US 2009/0150164 A1
(43) Pub. Date: Jun. 11, 2009

(54) TRI-MODEL AUDIO SEGMENTATION

(76) Inventors: Hu Wei, Beijing (CN); Yunfeng Du, Beijing (CN)

Correspondence Address: Barnes & Thornburg, LLP, c/o CPA Global, P.O. Box 52050, Minneapolis, MN, 55402, US

(21) Appl. No.: 11/951,825

(22) Filed: Dec. 6, 2007

(51) Int. Cl. G10L 19/00

(52) U.S. Cl. 704/500; 704/E19.001

(57) ABSTRACT

Apparatus, methods, and machine readable media that segment audio streams based upon application of three models to the audio stream are disclosed. One method includes extracting audio features from an audio stream and identifying a set of candidate change points between segments of the audio stream based upon the extracted audio features. The method further includes discarding a candidate change point between a first segment and a second segment in response to determining that a single multivariate Gaussian model represents the extracted audio features of the first segment and the second segment better than a first multivariate Gaussian model represents the extracted audio features of the first segment and a second multivariate Gaussian model represents the extracted audio features of the second segment.

### BACKGROUND

Audio segmentation, often called acoustic change detection, partitions an audio stream into homogenous segments by detecting changes of speaker identity, acoustic class or environmental condition. Audio segmentation may be used in audio clustering and classification as well as speaker clustering and tracking. Thus, audio segmentation plays a role in various applications such as multimedia indexing, spoken document retrieval and speech recognition.

Current approaches of audio segmentation may be categorized into two major groups: a model based approach and a metric based approach. The model based approach initializes a set of models for different acoustic classes from training corpus to classify the input audio stream so as to locate the changes. However, in many cases, the pre-knowledge of speakers and acoustic classes are often not available. Therefore, unsupervised metric-based approaches are desirable in many applications. In a metric-based approach, changes are determined by threshold on the basis of a distance computation for the input audio stream. Most of the distance measures come from statistical modeling framework, e.g. Kullback-Leibler (KL) distance, generalized likelihood ratio and Bayesian Information Criterion (BIC).

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a computing device that may be used to segment an audio stream.

FIG. 2 shows a flow chart of an embodiment of an audio segmentation process suitable for the computing device of FIG. 1.

FIG. 3 shows a resulting data flow of the embodiment of the audio segmentation process shown in FIG. 2.

FIG. 4 shows a candidate change point between two segments to that may be verified by the audio segmentation process of FIG. 2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be s+0read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

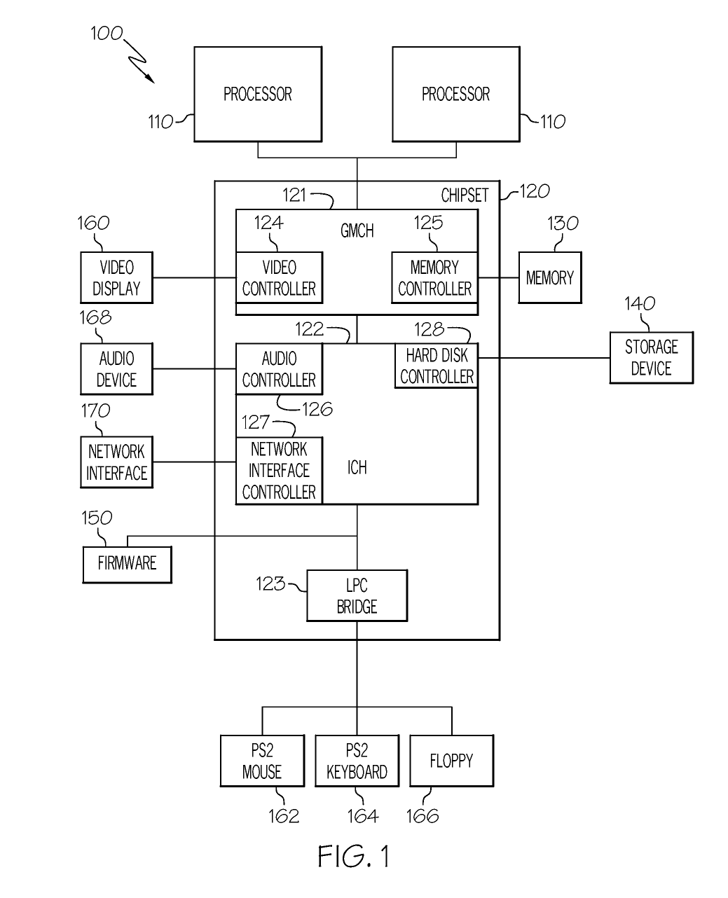

Referring now to FIG. 1, an embodiment of a computing device 100 that may segment an audio stream into a plurality of homogenous segments is shown. The computing device 100 may be embodied in various forms such as, for example, a desktop computer system, laptop computer system, a server computer system, or hand-held device. The computing device 100 may include one or more processors 110, a chipset 120, system memory 130, a storage device 140, and platform firmware device 150. It should be noted that while the computing device 100 is depicted in FIG. 1 with two processors 110, other embodiments of the computing device 100 may have a single processor 110 or more than two processors 110. The processors 110 may perform tasks in response to executing software instructions of the storage device 140 and/or firmware instructions of the platform firmware device 150.

As shown, the chipset 120 may include a graphical memory controller hub (GMCH) 121, an input/output controller hub (ICH) 122, and low pin count (LPC) bus bridge 123. The LPC bus bridge may connect a mouse 162, keyboard 164, floppy disk drive 166, and other low bandwidth devices to an LPC bus used to couple the platform firmware device 150 to the ICH. The graphical memory controller hub 121 may include a video controller 124 to control a video display 160 and a memory controller 125 to control reading from and writing to system memory 130. The system memory 130 may store instructions to be executed by the processors 110 and/or data to be processed by the processors 110. To this end, the system memory 130 may include dynamic random access memory devices (DRAM), synchronous DRAM (SDRAM), double-data rate (DDR) SDRAM, and/or other volatile memory devices.

As shown, the ICH 122 may include a network interface controller 127 to control a network interface 170 such as, for example, an Ethernet interface, and a hard disk controller 128 to control a storage device 140 such as an ATA (Advanced Technology Attachment) hard disk drive. Furthermore, the ICH 122 may include an audio controller 126 to send and received audio signals from audio devices 168 of the computing device. For example, the audio devices 168 may include audio output devices such as, for example, speakers to generate audible signals from audio signals received from the audio controller 126. The audio devices 168 may also include audio input devices such as microphones to provide the audio controller 126 with an audio signal representative of spoken words, commands, or other utterances of persons interfacing with the computing device 100. It should be appreciate that the computing device 100 may receive audio streams via sources other than the audio devices 168 and the audio controller 126. For example, the computing device 100 may receive an audio stream via the network interface 170 in response to executing a real-time audio/video conferencing application, a IP (Internet Protocol) telephony application, an audio playback application (e.g. MP3 player, CD player, or the like), a video playback application (e.g. DVD player) and/or some other audio/video application.

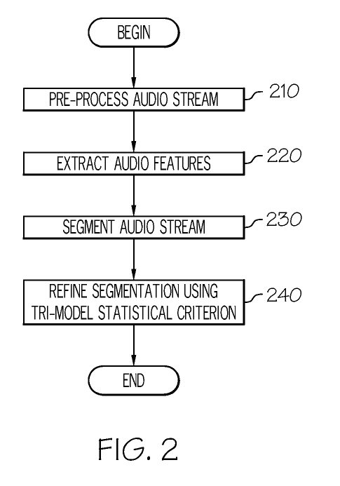

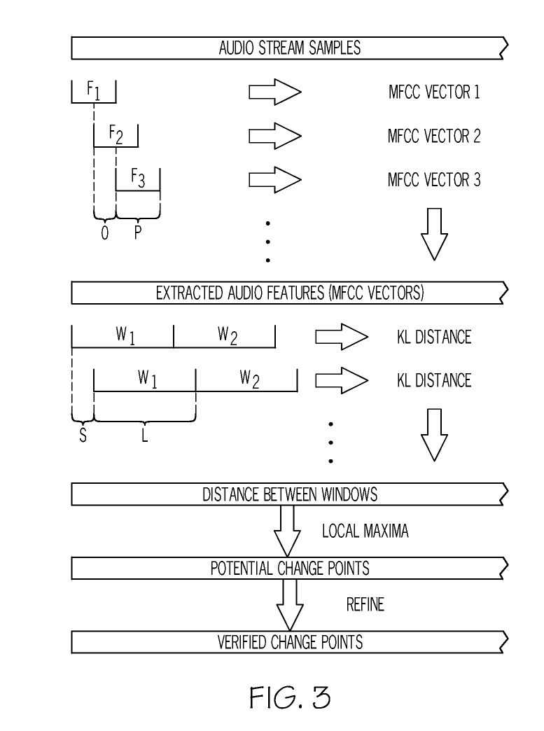

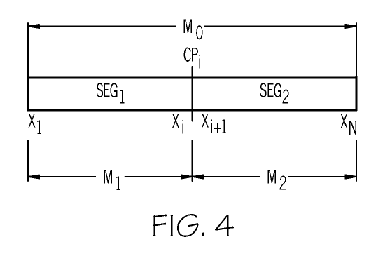

FIGS. 2-4 depict aspects of an embodiment of an audio segmentation process that may be implemented by the computing device 100. In particular, FIG. 2 shows a flowchart of an embodiment of the audio segmentation process; FIG. 3 shows a data flow of an embodiment of the audio segmentation process; and FIG. 4 shows a candidate change point that may be verified by an embodiment of the audio segmentation process. The audio segmentation process may begin at block 210 with pre-processing of the audio samples that make-up an audio stream. The computing device 100 may perform various operations in order to clean-up and/or adjust the audio samples of the audio stream for processing. For example, the computing device 100 may band-pass filter the audio stream in order to eliminate noise components and frequencies outside the range of human speech/hearing. Furthermore, if the audio stream is representative of a telephone conversion the audio stream likely contains substantial periods of silence. Accordingly, the computing device 100 may identify such silent portions of the audio stream and eliminate the audio samples associated with the silent portions of the audio stream.

At block 220, the computing device 100 may extract audio features from the pre-processed audio stream. In one embodiment, the computing device 100 may divide the audio stream into overlapping frames F₁, F₂, F₃ of audio samples as shown FIG. 3 and extract audio features from each overlapping frame F₁, F₂, F₃. In one embodiment, each frame of audio samples may be of a fixed period P (e.g. 20 milliseconds) and may have a fixed overlap O (e.g. 10 milliseconds) with a previous frame. Further, the computing device 100 may generate mel frequency cepstral coefficient (MFCC) vector from the audio samples of each overlapping frame F₁, F₂, F₃ and use the MFCC vector of each frame F₁, F₂, F₃ as the extracted audio features of the respected frame F₁, F₂, F₃.

At block 230, the computing device 100 may divide the audio stream into a plurality of segments based upon the extracted audio features. As shown in FIG. 3, the computing device 100 may compute a difference or divergence between two adjacent windows W₁, W₂ of extracted features shifted across the extracted audio features by a step S. In particular, the computing device 100 may compute the Kullback-Leiber distance between extracted features of a first window W₁ having a length L (e.g. 1000 milliseconds) and extracted features of a second window W₂ having the length L. The computing device 100 may then shift the first window W₁ and the second window W₂ by a step S (e.g. 0.1 seconds) and compute the Kullback-Leiber (KL) distance between the extracted features of the shifted first window W₁ and the shifted second window W₂. The computing device 100 may continue to shift the windows W₁, W₂ and compute the distance therebetween to obtain a set of distances or a graph of distances between adjacent windows W₁, W₂ of the audio stream with respect to time. The computing device 100 may then identify local maxima of the graph as candidate change points CP between segments of the audio stream. In one embodiment, the computing device 100 may low pass filter the distances to smooth the graph of distances before identifying local maxima as candidate change points.

While the above identifies computing the KL distance between windows, other measures of probability distance or divergence may also be used. For example, the computing device 100 may identify candidate change points based upon measures of probability distance such as histogram intersection, Chi-square statistic, quadratic form distance, match distance, Kolmogorov-Smirnov distance, and earth mover's distance to name a few.

The candidate change points provide a first pass segmentation of the audio stream. As shown in FIG. 4, a candidate change point CPᵢ identifies a boundary between two segments SEG₁, SEG₂ of the audio stream. At block 240, the computing device 100 may refine the segmentation of the audio stream by verifying each candidate change point CP and discarding candidate change points CP that the computing device 100 determines do not adequately represent a change point between homogenous segments. In particular, the computing device 100 may analyze a candidate change point CPᵢ by applying three models to the two segments SEG₁, SEG₂ separated by the candidate change point CPᵢ. In particular, the computing device 100 may discard a candidate change point CPᵢ and thereby adjoin two segments SEG₁, SEG₂ if a single multivariate Gaussian model M₀ represents the adjoined segments SEG₁, SEG₂ better than a first multivariate Gaussian model M₁ represents the first segment SEG₁ and a second multivariate Gaussian model M₂ represents the second segment SEG₂.

The computing device 100 may use statistical criterion to determine the quality of a model to represent the extracted features X={x₁, . . . , xₙ} of segments SEG₁, SEG₂. In one embodiment, the computing device may use Bayesian Information Criterion (BIC) to determine the quality of a single model M₀ to represent the extracted features of the adjoined segments SEG₁, SEG₂, the quality of a first model M₁ to represent the first segment SEG₁, and the quality of a second model M₂ to represent the extracted features of a second segment SEG₂. BIC is generally a likelihood criterion that is penalized by the model complexity. The quality of a model M to represent a data sequence X={x₁, . . . , xₙ} is given by equation (1):

BIC(M)=Log L(x₁, . . . , xₙ|M)−0.5λK(M)log N (1)

where L(x₁, . . . , xₙ|M) represents the likelihood of model M estimated from data sequence X via maximum likelihood principle, K(M) represents the complexity of model M equal to the number of free parameters. Furthermore, X is a penalty weight, theoretically equal to 1 but may be used as a tunable threshold parameter. Based upon BIC, a first model M₁ represents a data sequence X={x₁, . . . , xₙ} better than a second model M₂ if BIC(M₁) is greater than BIC(M₂) or the difference ΔBIC of BIC(M₂) subtracted from BIC(M₁) is greater than zero (0).

Referring to FIG. 4, adjoining segments SEG₁, SEG₂ may comprise extracted features X₀={x₁, . . . , xₙ} with sub sequence X₁={x₁, . . . , xₙ} corresponding to the first segment SEG₁ and sub sequence X₂={xᵢ₊₁, . . . , xₙ} corresponding to the second segment SEG₂. The computing device 100 may generate a quality value BIC(M₀) for the extracted features X₀={x₁, . . . , xₙ} of adjoined segments SEG₁, SEG₂ using a single multivariate Gaussian model M₀=N(μ₀, Σ₀) where μ₀ represents the mean vector and Σ₀ represents the covariance matrix of the multivariate Gaussian model M₀. Similarly, the computing device 100 may generate a quality value BIC(M₁) for the extracted features X₁={x₁, . . . , xₙ} of the first segment SEG₁ using a first multivariate Gaussian model M₁=N(μ₁, Σ₁) where μ₁ represents the mean vector and Σ₁ represents the covariance matrix of the multivariate Gaussian model M₁. The computing device 100 may also generate a quality value BIC(M₂) for the extracted features X₂={xᵢ₊₁, . . . , xₙ} of the second segment SEG₂ using a second multivariate Gaussian model M₂=N(μ₂, Σ₂) where μ₂ represents the mean vector and Σ₂ represents the covariance matrix of the multivariate Gaussian model M₂. Quality values BIC(M₀), BIC(M₁), and BIC(M₂) are presented below as equations 2-4.

BIC(M₀)=Log L(x₁, . . . , xₙ|μ₀, Σ₀)−0.5λK(M₀)log N (2)

BIC(M₁)=Log L(x₁, . . . , xₙ|μ₁,Σ₁)−0.5λK(M₁)log N₁ (3)

BIC(M₂)=Log L(x₁, . . . , xₙ|μ₂,Σ₂)−0.5λK(M₂)log N₂ (4)

The computing device 100 may determine the difference ΔBIC between the quality value BIC(M₀) for the single model representation of the adjoined segments SEG₁, SEG₂ and the sum of the quality value BIC(M₁) for the first model representation of the first segment SEG₁ and the quality value BIC(M₂) for the second model representation of the second segment SEG₂. Such a difference ΔBIC is depicted by equation 5 which follows:

$$\begin{matrix}Δ B I C = B I C ( {M}_{0} ) - B I C ( {M}_{1} ) - B I C ( {M}_{2} ) \\ = 0.5 {N}_{1} log \vert {\sum }_{1} \vert + 0.5 {N}_{2} log \vert {\sum }_{2} \vert - \\ 0.5 N log \vert {\sum }_{0} \vert - 0.5 λ ( d + 0.5 d ( d + 1 ) ) \\ ( log N - log {N}_{1} - log {N}_{2} )\end{matrix} \qquad ( 5 )$$

A negative value of the difference ΔBIC indicates that the quality of modeling the extracted features X₀={x₁, . . . , xₙ} of both segments SEG₁, SEG₂ by a single multivariate Gaussian process is less than the overall quality of modeling the extracted features X₀={x₁, . . . , xₙ} as two individual multivariate Gaussian processes. Thus, the computing device 100 may elect to retain a change point CPᵢ if the difference ΔBIC is less than zero (0) and may elect to discard the change point CPᵢ if the difference ΔBIC is greater than zero (0). At block 240, the computing device 100 may repeat the above process for each candidate change point in order to verify the candidate change point CP and discard those change points CP the computing device 100 determines do not adequately indicate a change between two homogenous segments.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method, comprising
extracting audio features from an audio stream,
identifying a set of candidate change points between segments of the audio stream based upon the extracted audio features, and
discarding a candidate change point between a first segment and a second segment in response to determining that a single multivariate Gaussian model represents the extracted audio features of the first segment and the second segment better than a first multivariate Gaussian model represents the extracted audio features of the first segment and a second multivariate Gaussian model represents the extracted audio features of the second segment.

2. The method of claim 1, wherein extracting audio features from the audio stream comprises generating mel frequency cepstral coefficient vectors for frames of the audio stream.

3. The method of claim 1, wherein extracting audio features from the audio stream comprises
dividing the audio stream into a plurality of overlapping frames, and
generating a mel frequency cepstral coefficient vector for each frame of the plurality of overlapping frames.

4. The method of claim 1, wherein extracting audio features from the audio stream comprises
dividing the audio stream into a plurality of 20 millisecond frames that overlap adjacent frames by 10 milliseconds, and
generating a mel frequency cepstral coefficient vector for each frame of the plurality of 20 millisecond frames.

5. The method of claim 1, wherein discarding the candidate change point comprises determining based upon a statistical criterion for model selection that the single multivariate Gaussian model represents the extracted audio features of the first segment and the second segment better than the first multivariate Gaussian model represents the extracted audio features of the first segment and the second multivariate Gaussian model represents the extracted audio features of the second segment.

6. The method of claim 1, wherein discarding the candidate change point comprises determining based upon Bayesian information criterion that the single multivariate Gaussian model represents the extracted audio features of the first segment and the second segment better than the first multivariate Gaussian model represents the extracted audio features of the first segment and the second multivariate Gaussian model represents the extracted audio features of the second segment.

7. A machine readable medium comprising a plurality of instruction that, in response to being executed, result in a device
extracting audio features from an audio stream,
identifying a set of candidate change points between segments of the audio stream based upon the extracted audio features, and
retaining a candidate change point of the set of candidate change points between a first segment and a second segment if a first model represents the extracted audio features of the first segment and a second model represents the extracted audio features of the second segment better than a single model represents the extracted audio features of the first segment and second segment.

8. The machine readable medium of claim 7 wherein the plurality of instructions further result in the device discarding the candidate change point if the single model represents the extracted audio features of the first segment and second segment better than the first model represents the extracted audio features of the first segment and the second model represents the extracted audio features of the second segment.

9. The machine readable medium of claim 7 wherein the plurality of instructions further result in the device generating mel frequency cepstral coefficient vectors for frames of the audio stream in response to extracting audio features from the audio stream.

10. The machine readable medium of claim 7 wherein the plurality of instructions further result in the device extracting audio features from the audio stream comprises by
dividing the audio stream into a plurality of overlapping frames, and
generating a mel frequency cepstral coefficient vector for each frame of the plurality of overlapping frames.

11. The machine readable medium of claim 7 wherein the plurality of instructions further result in the device retaining the candidate change point in response to determining based upon a statistical criterion for model selection that a first multivariate Gaussian model represents the extracted audio features of the first segment and a second multivariate Gaussian model represents the extracted audio features of the second segment better than a single multivariate Gaussian model represents the extracted audio features of the first segment and second segment.

12. The machine readable medium of claim 7 wherein the plurality of instructions further result in the device retaining the candidate change point in response to determining based upon Bayesian information criterion that a first multivariate Gaussian model represents the extracted audio features of the first segment and a second multivariate Gaussian model represents the extracted audio features of the second segment better than a single multivariate Gaussian model represents the extracted audio features of the first segment and second segment.

13. The machine readable medium of claim 7 wherein the plurality of instructions further result in the device retaining the candidate change point in response to a Bayesian information criterion value for a single multivariate Gaussian model applied to the extracted audio features of the first segment and a second segment being greater than the sum of a first Bayesian information criterion value for a first multivariate Gaussian model applied to the extracted audio features of the first segment and a second Bayesian information criterion value for a second multivariate Gaussian model applied to the extracted audio features of the second segment.

14. The machine readable medium of claim 7 wherein
the single model comprises a single multivariate Gaussian model,
the first model comprises a first multivariate Gaussian model, and
the second model comprises a second multivariate Gaussian model.

15. A computing device, comprising
an audio input to provide an audio stream based upon received input,
a memory comprising a plurality of instructions,
a processor to execute the plurality of instructions, wherein
the plurality of instructions in response to being executed result in the processor extracting audio features from the audio stream, identifying a set of candidate change points between segments of the audio stream based upon the extracted audio features, discarding a candidate change point between a first segment and a second segment if a single multivariate model represents the extracted audio features of the first segment and the second segment better than a first multivariate model represents the extracted audio features of the first segment and a second multivariate model represents the extracted audio features of the second segment, and retaining the candidate change point of the set of candidate change points between the first segment and a second segment if the first model represents the extracted audio features of the first segment and the second model represents the extracted audio features of the second segment better than the single model represents the extracted audio features of the first segment and second segment.

16. The computing device of claim 15, wherein
the single model comprises a single multivariate Gaussian model,
the first model comprises a first multivariate Gaussian model, and
the second model comprises a second multivariate Gaussian model.

17. The computing device of claim 16, wherein the plurality of instructions further result in the processor extracting audio features from the audio stream by dividing the audio stream into a plurality of overlapping frames, and generating a mel frequency cepstral coefficient vector for each frame of the plurality of overlapping frames.

18. The computing device of claim 17, wherein the plurality of instructions further result in the processor discarding the candidate change point in response to a Bayesian information criterion value for the single multivariate Gaussian model applied to the extracted audio features of the first segment and the second segment being smaller than the sum of a first Bayesian information criterion value for the first multivariate Gaussian model applied to the extracted audio features of the first segment and a second Bayesian information criterion value for the second multivariate Gaussian model applied to the extracted audio features of the second segment.

19. The computing device of claim 17, wherein the plurality of instructions further result in the processor determining based upon Bayesian information criterion whether the single multivariate Gaussian model represents the extracted audio features of the first segment and the second segment better than the first multivariate Gaussian model represents the extracted audio features of the first segment and the second multivariate Gaussian model represents the extracted audio features of the second segment.

20. The computing device of claim 19, wherein the plurality of instructions further result in the processor identifying the set of candidate change points by computing a symmetric Kullback-Leiber distance between two adjacent windows shifted by a fixed time step across the extracted features to obtain a set of distances Kullback-Leiber distances for the audio stream with respect to time, and selecting local maxima of the set of distances as candidate change points.
